(19) United States
(12) Patent Application Publication
(10) Pub. No.: US 2004/0173051 A1
(43) Pub. Date: Sep. 9, 2004

(54) Breather system for a housing containing a lubricant sump

(76) Inventors: Aaron Alexander Sinka, Royal Oak, MI (US); Richard Gady, Rochester Hills, MI (US); John L. Bennett, Fraser, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/382,180

(22) Filed: Mar. 5, 2003

(51) Int. Cl. F16H 57/02

(52) U.S. Cl. 74/607

(57) ABSTRACT

A breather system includes a by-pass having an internal wall to collect lubricant while air flows upward out of a first outlet. Lubricant which has separated from lubricant laden air flows downward through a second outlet and into a conduit under the force of gravity and reenters the housing through a return opening. Another breather system includes a second conduit pressurized by a pump to creates a pressure vacuum within the conduit to forcefully draw lubricant through the conduit from the by-pass.

### BACKGROUND OF THE INVENTION

The present invention relates to a breather system for a lubricant housing, and more particularly to a gearbox in a vehicle drive axle.

Conventional drive axle assemblies typically include a gearing arrangement which rotates and churns in a lubricant sump within a sealed housing. Unless relieved, operating temperature fluctuations caused by the operation of the gearing arrangement may result in a buildup of a vacuum or excessive pressure within the housing. Excessive pressure may result in damage to the seals, improper lubricant flow and/or less than optimal operation of the axle mechanism.

To relieve built-up vacuum and/or pressure within a drive axle housing, it is known to provide a venting device, usually referred to as a breather. In some instances it may be difficult to separate the lubricant from the air prior to exiting the breather. Disadvantageously, lubricant blow out from the breather may reduce performance through a reduction in lubricant and a resultant increase in gearbox temperature. Furthermore, lubricant blow out may generate an environmental concern in some localities.

Accordingly, it is desirable to provide a breather system which effectively vents a sealed gear housing while minimizing lubricant blow out therefrom.

### SUMMARY OF THE INVENTION

The breather system according to the present invention vents a gearbox while minimizing lubricant loss. Pressure within the housing is often greater than atmospheric pressure due to operation of the gearing arrangement such that lubricant laden air exits the housing through a vent opening.

Lubricant laden air exits the vent opening and strikes an internal wall of a T-shaped by-pass. Lubricant collects upon the internal wall while air flows upward out of a first outlet. Lubricant which has separated from the lubricant laden air flows downward through a second outlet and into a conduit under the force of gravity. The conduit communicates through a return opening in the housing above the lubricant level of the lubricant sump. The lubricant is thereby recirculated.

Another breather system locates the return opening below the lubricant level of the lubricant sump. A second conduit pressurized by a pump provides a pressure which creates a pressure vacuum within the conduit to forcefully draw lubricant from the bypass.

The present invention therefore provides a breather system which effectively vents a sealed gear housing while minimizing lubricant blow out therefrom.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of an axle assembly for use with the present invention;

FIG. 2 is a sectional view of a gearbox having a sump and a breather system according to the present invention; and

FIG. 3 is a sectional view of a gearbox having a sump and another breather system according to the present invention.

### DETAILED DESCRIPTION OF THE PREFERRED EMBODIMENT

FIG. 1 illustrates a general perspective view of a drive axle assembly 10. The drive axle assembly 10 includes an axle housing 12 and a gear box housing 14 which contains a gearing arrangement (illustrated schematically at 16). The axle housing 12 also defines a generally bowl-shaped area 18 where the differential casing meets the arms 20 of the axle housing 12. It should be understood that although an axle assembly is disclosed in the illustrated embodiment, various gearboxes that require breather systems will benefit from the present invention.

As is known, the gearing arrangement 16 of the drive axle assembly 10 rotates and chum within a lubricant sump S which partially fills the axle housing 12 and gear box housing 14 which is maintained therein by seals and the like. Such rotation and churning within the axle housing may result in a vacuum or pressure buildup within the housing which, unless relieved, may adversely affect the operation of the housing and/or functioning of the various seal elements and the like.

A breather system 22 is preferably located adjacent the bowl-shaped area 18. It should be understood that other locations for the breather system 22 will also benefit from the present invention. The breather system 22 generally includes a by-pass 24 which communicates with a vent opening 26 and a conduit 28 which communicates with the by-pass 24 and a return opening 30. The vent opening 26 is preferably above the return opening 30 relative the ground.

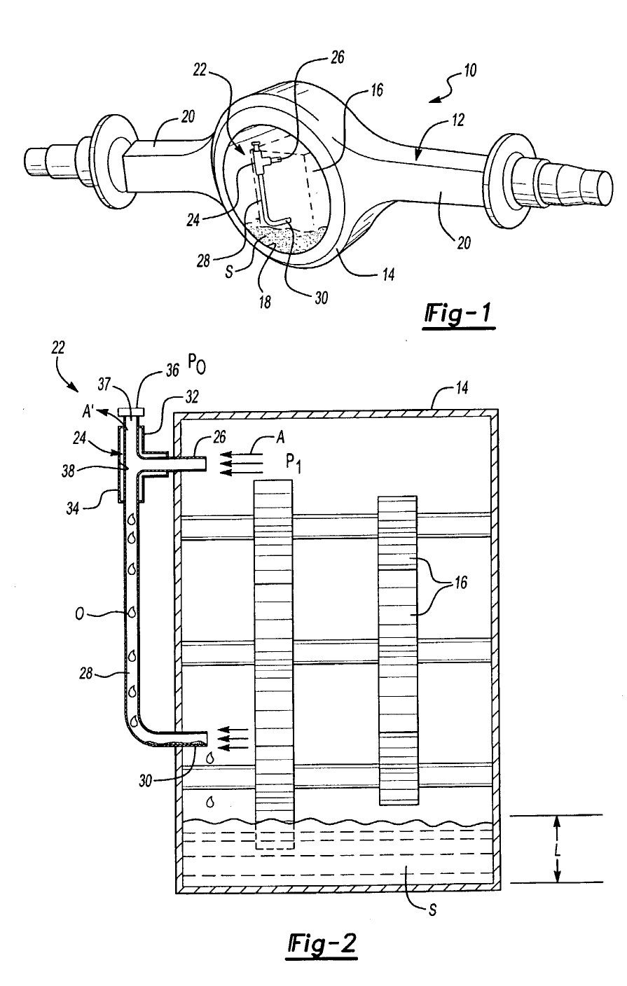

Referring to FIG. 2, the breather system 22 communicates with the gear box housing 14 to vent pressure therein while minimizing lubricant loss from sump S. Pressure P 1 within the gear box housing 14 is greater than atmospheric pressure P0 due to operation of the gearing arrangement 16 such that lubricant laden air (illustrated schematically by arrow A) exits the gear box housing 14 through the vent opening 26.

Preferably, the by-pass 24 is a T-shaped member having a first outlet 32 facing upward relative to ground and a second outlet 34 facing downward toward the ground. It should be understood that the first outlet 32 need not be directly opposite the second outlet and that geometry other than a T-shape will also benefit from the present invention.

The first outlet 32 includes a shield 36 which minimizes debris and external water entrance into the by-pass 24 while providing an exit for the air. Various filters 37 and the like will also benefit from the present invention. The lubricant laden air A exits the vent opening 26 and strikes an internal wall 38 of the by-pass 24 between the first outlet 32 and the second outlet 34. The internal wall 38 is generally transverse to the flow of the lubricant laden air A. Lubricant collects upon the internal wall 38 while air (illustrated schematically by arrow A′) flows upward out of the first outlet 32.

Lubricant illustrated schematically by arrow O which has separated from the lubricant laden air A flows downward through second outlet 34 and into conduit 28 under the force of gravity. The lubricant O communicates through the conduit 28 and reenters the gear box housing 14 through the return opening 30. Lubricant laden air A will exit the gear box housing 14 through the return opening 30 which will effectively respond as described with the by-pass 24. That is, lubricant laden air A will have lubricant collect within the conduit 28 while air A′ will continue through the conduit 28 and exit the first outlet 28.

The return opening 30 is preferably above the lubricant level L with the lubricant sump S to minimize the potential for an air lock within the conduit 28. The conduit 28 and the return opening 30 are preferably of a relatively large size to reduce the exhaust pressure from the return opening 30. That is, the return opening 30 may be larger than the vent opening 26. The larger size of the return opening 30 also minimizes the potential for a meniscus to form and create and air lock.

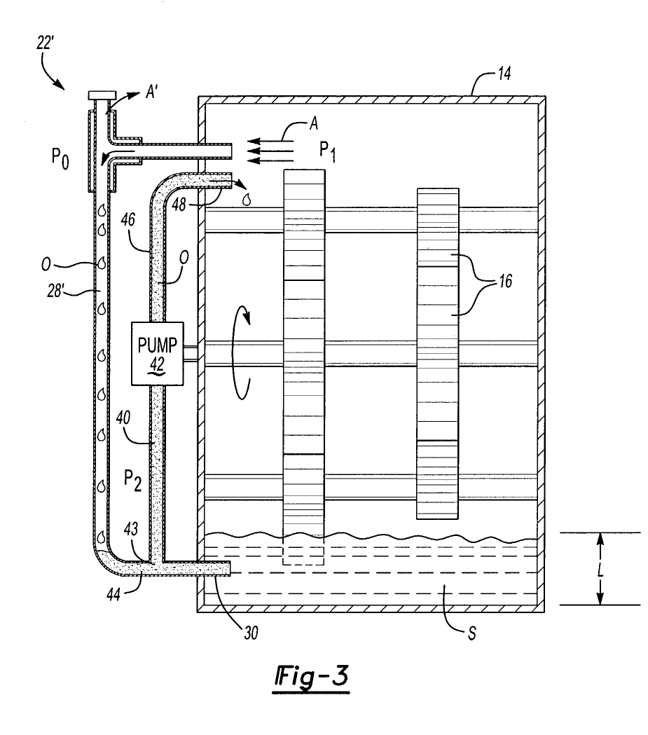

Referring to FIG. 3, another breather system 22′ is illustrated. The breather system 22′ locates the return opening 30′ below the lubricant level L with the lubricant sump S and a second conduit 40 pressurized by a pump 42 is provided. The pump 42 is preferably powered by the gear arrangement 16. The second conduit 40 communicates with the conduit 28′ at a junction 43 below the lubricant level L and provides a pressure P2 which is below atmospheric pressure P0. That is, the conduit 28′ preferably includes a segment 44 which is substantially parallel to the lubricant level L within the lubricant S to provide a sump for conduit 40. The vacuum within the second conduit 40 thereby creates a pressure vacuum within the conduit 28′ forcefully draw lubricant O through the conduit 28′.

An exit line 46 from the pump 42 circulates lubricant O from the lubricant level L within the conduit 28′ back into the gear box housing 14 through an injection opening 48. The exit line 46 is preferably located to inject lubricant toward the upper portion of the gear box housing 14. Moreover, as the vacuum within the second conduit 40 creates a pressure vacuum within the conduit 28′, the sizing of conduit 28′ is of lesser concern.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A breather system for a housing containing a lubricant sump comprising:
a by-pass in communication with a vent opening within a housing, said by-pass opening comprising a first output and a second output; and
a conduit in communication with said second output and a return opening in the housing.

2. The breather system as recited in claim 1, wherein said return opening is above a lubricant level of a lubricant sump.

3. The breather system as recited in claim 1, wherein said by-pass comprises a T-shaped member.

4. The breather system as recited in claim 1, further comprising an internal wall between said first output and said second output, said internal wall substantially perpendicular to said vent opening.

5. The breather system as recited in claim 1, wherein said first output is opposite said second output.

6. The breather system as recited in claim 1, further comprising a shield over said first output.

7. The breather system as recited in claim 1, further comprising a filter over said first output.

8. The breather system as recited in claim 1, wherein said return opening is below a lubricant level of a lubricant sump.

9. The breather system as recited in claim 8, further comprising a second conduit in communication with said first conduit at ajunction below said lubricant level.

10. The breather system as recited in claim 9, further comprising a pump in communication with said second conduit.

11. The breather system as recited in claim 9, further comprising an exit line in communication with second conduit and an injection opening in the housing.

12. The breather system as recited in claim 1, further comprising a pump between said second conduit and said exit line.

13. A gearbox assembly comprising:
a gearbox housing containing a lubricant sump defining a lubricant level;
a by-pass in communication with a vent opening in said housing above said lubricant level, said by-pass comprising a first output and a second output; and
a conduit in communication with said second output and a return opening in said housing, said return opening above said lubricant level.

14. The assembly as recited in claim 13, further comprising an internal wall between said first output and said second output, said internal wall substantially perpendicular to said vent opening.

15. The assembly as recited in claim 13, wherein said housing comprises a differential carrier housing of an axle assembly.

16. The assembly as recited in claim 13, wherein said return opening is larger than said vent opening.

17. A gearbox assembly comprising:
a gear box housing containing a lubricant sump defining a lubricant level;
a by-pass in communication with a vent opening in said housing, said vent opening above said lubricant level, said by-pass comprising a first output and a second output;
a conduit in communication with said second output and a return opening in said housing; said return opening below said lubricant level; and
a second conduit in communication with said first conduit below said lubricant level.

18. The assembly as recited in claim 17, further comprising an internal wall between said first output and said second output, said internal wall substantially perpendicular to said vent opening.

19. The assembly as recited in claim 17, further comprising a pump in communication with said second conduit and an exit line, said injection line in communication with an injection opening in said housing.

20. The assembly as recited in claim 17, wherein said housing comprises a differential carrier housing of an axle assembly.
